(19) United States
(12) Patent Application Publication
(10) Pub. No.: US 2018/0082565 A1
(43) Pub. Date: Mar. 22, 2018

(54) METHOD OF CONTROLLING LOCATION MONITORING AND REPORTING

(71) Applicant: PRECYSE, INC., Arlington, VA (US)

(72) Inventor: Michael BRAIMAN, Alpharetta, GA (US)

(73) Assignee: PRECYSE TECHNOLOGIES, INC., Atlanta, GA (US)

(21) Appl. No.: 15/563,179

(22) PCT Filed: Mar. 29, 2016
(86) PCT No.: PCT/US2016/024702

§ 371 Date: Sep. 29, 2017

Related U.S. Application Data
(63) Continuation-in-part of application No. 14/765,034, filed on Jul. 31, 2015, now Pat. No. 9,619,988.
(60) Provisional application No. 61/759,079, filed on Jan. 31, 2013.
(60) Provisional application No. 62/140,050, filed on Mar. 30, 2015.
(60) Provisional application No. 62/158,870, filed on May 8, 2015.
(60) Provisional application No. 62/190,543, filed on Jul. 9, 2015.

(51) Int. Cl. G08B 21/04; G08B 21/12; G08B 21/08; G08B 25/14

(52) U.S. Cl. CPC G08B 21/0492; G08B 21/12; G08B 25/14; G08B 21/088; G08B 21/0446

(57) ABSTRACT

A method comprises: receiving a signal from a first device that is part of a tag, the tag adapted to be affixed to a person or object, the receiving being performed by a processor within the tag; analyzing the signal within the processor to determine whether the person or object is performing a predetermined type of behavior; adjusting a variable rate of transmitting a monitoring signal from the tag, based on a result of the analyzing, the adjusting being controlled by the processor; and transmitting the monitoring signal from the tag to an external device separate from the tag at the adjusted variable rate.

### INCORPORATION BY REFERENCE

This application is a continuation-in-part of U.S. application Ser. No. 14/765,034, filed Jul. 31, 2015, which is a 371 National Stage of International Application No. PCT/US2014/13312, filed Jan. 28, 2014, which claims the benefit of U.S. Provisional Application No. 61/759,079, filed Jan. 31, 2013, the entire disclosures of which are incorporated by reference in their entireties. This application claims the benefit of priority of U.S. Provisional Patent Application No. 62/140,050, filed Mar. 30, 2015, U.S. Provisional Patent Application No. 62/158,870, filed May 8, 2015, and U.S. Provisional Patent Application No. 62/190,543, filed Jul. 9, 2015, the entire disclosures of which are each incorporated by reference herein in their entireties.

### FIELD

This disclosure relates to sensor devices operating in collaboration with RTLS or any other personal communication or location devices.

### BACKGROUND

Gas sensing is a major parameter for gas drilling and transportation industries. These sensors can detect the concentration of gas in the air. For example, the sensors can detect the presence of CO, CO2, or other gas. To ensure safety and security in the workplace, it is desirable to monitor various densities to prevent any overdose or underdose situations that may become life threatening. A variety of individual portable gas detecting devices are available on the market for monitoring of a gas concentrations in the air.

The sensors can be independent gas sensors. Independent sensors have a local display and/or alarm. These sensors are local and are not configured to transmit data back to a central control station. A person reads the display visually. Such devices are detectors only, providing the local employee with the current gas concentration and alarms.

### BRIEF DESCRIPTION OF THE DRAWINGS

FIG. 1 is a flow chart of a method.

FIG. 2 is a flow chart of an embodiment of the method of FIG. 1.

FIG. 3 is a diagram of a table for determining location monitoring rate in a method according to FIG. 1 or FIG. 2.

FIG. 4 is a diagram of a continuous function for determining location monitoring rate in a method according to FIG. 1 or FIG. 2.

FIG. 5 is a flow chart of a method for defining a predetermined reference behavior to be used in a method according to FIG. 1 or FIG. 2.

FIG. 6 is a flow chart of another embodiment of the method of FIG. 1.

FIG. 7 is a schematic diagram of a system for performing the method of FIG. 1

FIG. 8 is a schematic diagram of the tag as shown in FIG. 7.

FIG. 9 is a schematic diagram of the base station shown in FIG. 7.

FIG. 10 is a schematic diagram of the beacon shown in FIG. 7.

FIG. 11 is a schematic diagram of a system including a paired remote sensor detector according to some embodiments.

FIG. 12 is a schematic diagram of a plurality of remote sensor detectors coupled to a wireless gateway, according to some embodiments.

FIG. 13 is a schematic diagram of a paired remote sensor detector according to some embodiments used to detect location and/or behavior of a person.

FIGS. 14A-14C show a relay device according to some embodiments.

FIGS. 15A-15B show a relay device according to some embodiments.

FIGS. 16A-16B show a relay device according to some embodiments.

FIG. 17 is a front view of an embodiment of a vest with the remote sensor and a the main communication device attached thereto.

FIG. 18 is a schematic showing a system having the sensor and main communication device of FIG. 17.

FIG. 19 is a schematic diagram of an exemplary system for hazard detection and alerts.

FIG. 20 shows the system of FIG. 19 when two hazardous conditions have been detected.

FIG. 21 is a flow chart of a method for HA data acquisition from the Sensors to the Server via Data Communication Station and HAD list generation

FIG. 22 is a flow chart of a method for issuing an alert after comparing the current mobile device location vs. HAD list.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Combined detection/communication devices integrate a detector with a wired or wireless communication module. Such products combine gas detectors with active RFID/RTLS personal devices, transmitting to the back office the measured gas concentrations and alarms, while accompanying them with the employee's ID and his current location.

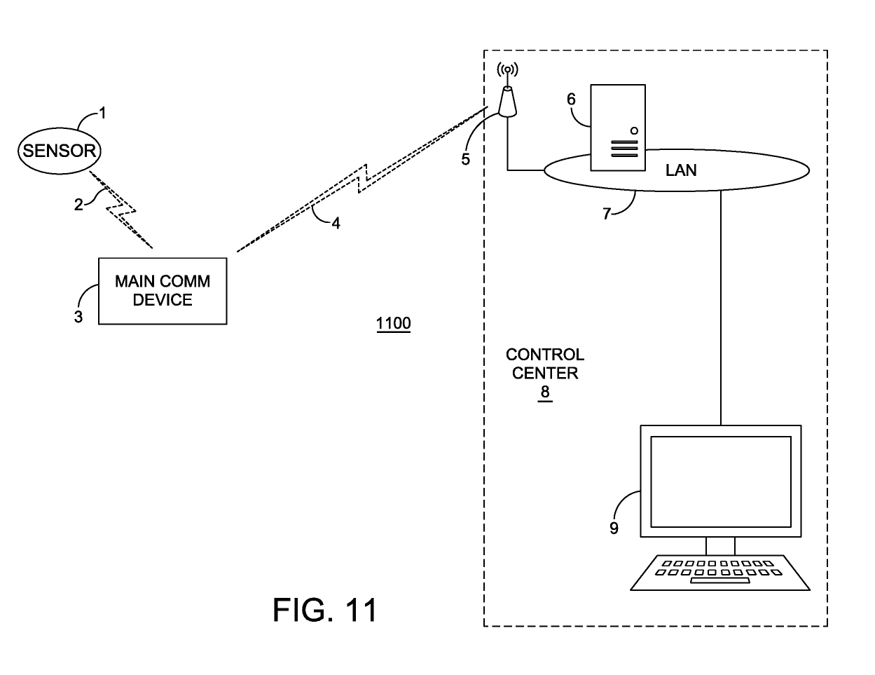

FIG. 11 is a schematic diagram of a system 1100 according to some embodiments. In some embodiments, the system 1100 comprises: a main communication device 3 that can provide wireless data communication to a server 6 (e.g., a data processing and business application server) and one or more sensors 1 (e.g., a remote gas sensor device) in communication with the main communication device 3 (e.g., a main long range identification, location and communication device). The main communication device 3 may be an Active radio frequency identification (RFID)/Real-Time Location System (RTLS) device, or Smart Agent (such as a Precysetech Remote Entity Awareness and Control (REAC) device sold by Precyse Technologies, Inc. of Atlanta, Ga.) or any other device designed to provide personal identification, along with wireless communication, location and other functions. In some embodiments, the main communication device 3 provides acceleration data from a sensor 1, such as an accelerometer. The remote sensor 1 and the main communication device 3 can be affixed to the same person, but still remain as separate devices.

The method allows any main communication device 3 to be wirelessly paired with one or more remote sensors 1 affixed to the same person to act as a wireless data relay between the sensor(s) 1 and a server 6, which can be located remotely in a control center 8. For example, in some embodiments, the method reports the actual gas concentrations from one or more gas sensors 1 to the control center 8 in real time. The sensor(s) 1 are coupled to the main communication device 3 via a local communication interface 2. The main communication device 3 communicates with the server 6 via a long range wireless communications link 4. The control center 8 has an antenna 5 for long range communication, a server 6, a local area network (LAN) 7 (such as a corporate network using internet protocol, IP). The system 1100 allows the control center 8 to continuously monitor the employee's ambient environment at a remote display 9 and react quickly in case of any unexpected event.

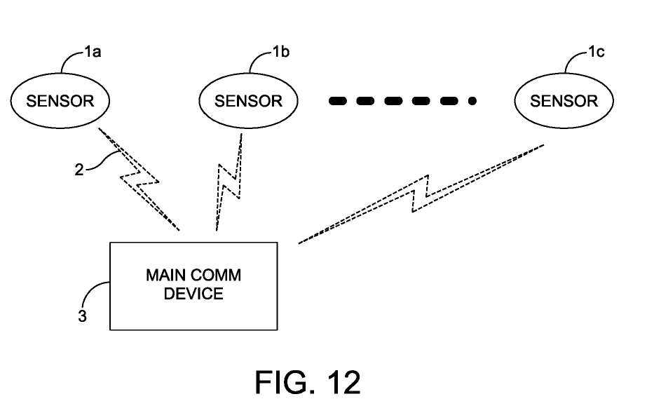

FIG. 12 is a schematic diagram of a system including a single main communications device 3 in wireless communication with a plurality of sensors 1a-1c. Although this example shows three sensors 1a-1c, the main communications device 3 can support any number of sensors. The sensors 1a-1c can be different from each other. For example, in some embodiments, each sensor 1a-1c senses a respectively different gas. In some embodiments, one or more sensors 1a-1c can detect ambient temperature, pressure, location, acceleration or the like. In some embodiments, one or more sensors 1a-1c can detect the levels of respectively different types of radiation (e.g., X-rays, gamma rays, solar radiation, ultraviolet radiation, infrared radiation, alpha particles, or the like). The sensors 1a-1c communicate with the main communications device 3 via a short range wireless link. For example, the sensors can communicate using an RF ID or RTLS protocol, over an RF, IR, optical, or audio medium.

In some embodiments, the local communication interface 2 is wireless. The main communication device 3 has one or more interfaces 2 to establish a short range communication to the remote sensor, such as: an RF link (which can be a proprietary protocol, Bluetooth, Wi-Fi or other protocol.), an optical link (such as: Infra-Red transmitter and receiver), an audio speaker and microphone, or the like. The remote sensor 1 can support at least one of the above mentioned wireless communication protocols as well. In other embodiments, the communication interface 2 includes a wired connector.

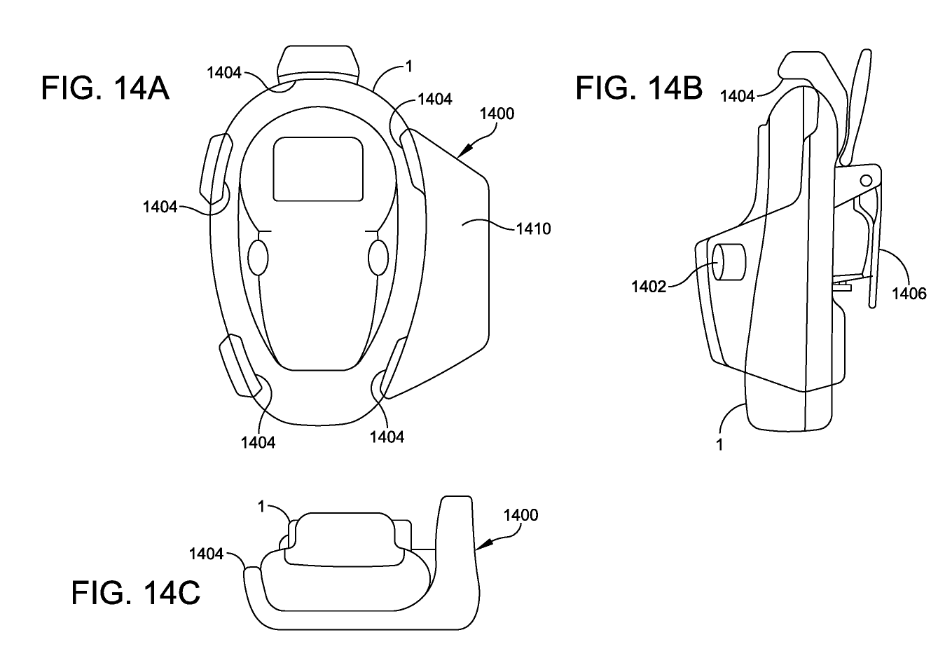

In some embodiments, the sensors 1a-1c and the main communication device 3 use different communication protocols, and a wireless gateway or relay device can be used to bridge between the sensors and the main communication device 3. In some embodiments, as shown in FIGS. 14A to 16B, this relay device can be provided in a form of a holder, wrapping the sensor device, communicating with the sensor using a communication protocol and physical interface supported by the sensor device. The relay device relays the data to the main communication device using the communication protocol of the main communication device.

FIGS. 14A-14C show an example of a gateway relay device 1400 according to some embodiments. FIG. 14A is a front elevation view. FIG. 14B is a right side elevation view. FIG. 14C is a bottom plan view. The relay device 1400 receives and holds the sensor 1. In some embodiments, the relay device 1400 communicates with the sensor 1 via wireless communication. An electronics section 1410 houses the electronics (which may include, but are not limited to, a processor, memory, an antenna, and communications interfaces) and a battery. In other embodiments, the relay device 1400 has a connector (not shown) for docking the sensor 1. The relay device has a means 1402 for receiving signals from the sensor 1. In some embodiments, the sensors 1 emit RF signals, and the receiving means 1402 include an RF antenna and transceiver for wireless communication with the sensors 1. In some embodiments, the sensors 1 emit IR signals, and the receiving means 1402 include an IR sensor and transceiver for wireless communication with the sensor 1. The relay device 1400 can have a plurality of gripping members 1404 for receiving and holding the sensor 1. The sensor 1 is pushed into the relay device 1400 from the front. The gripping members 1404 are sufficiently flexible to allow the sensor 1 to be pushed into place, and then return elastically to their original shape. In some embodiments the relay device 1400 is formed of a plastic, such as polycarbonate or polyurethane. In some embodiments, the sensor 1 has a clip 1406 for fastening the sensor 1 to an article of clothing (e.g., a belt) of the user or to any object traveling with the user. In other embodiments (not shown) the relay device 1400 can have a clip for fastening the relay device to an article of clothing or object.

In other embodiments, the relay device 1400 includes all the functionality of the main communication device 3. The relay 1400 communicates with the sensors 1 and communicates directly with the central station 8.

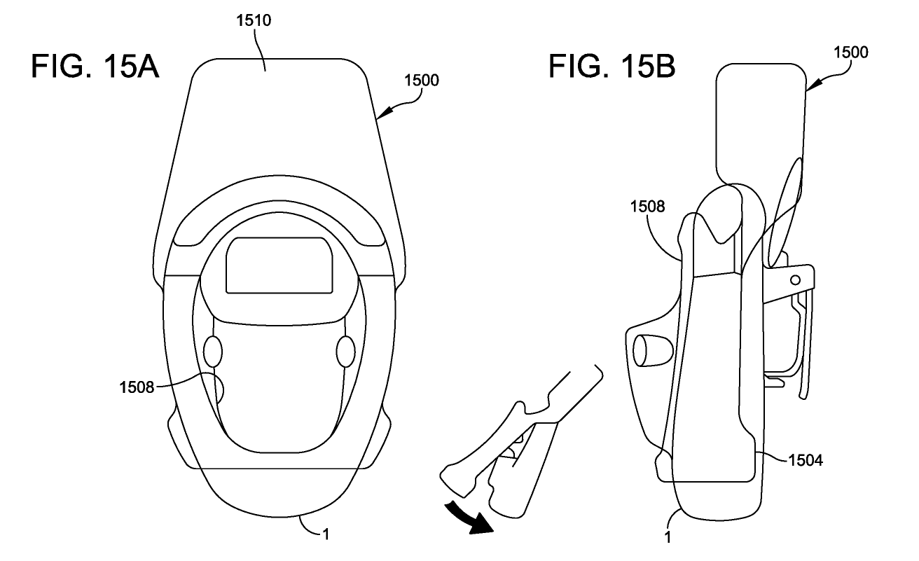

FIGS. 15A and 15B show another embodiment of a relay device 1500. The relay device 1500 is functionally identical to the relay device 1400, but the arrangement is different. An electronics section 1510 houses the electronics (which may include, but are not limited to, a processor, memory, an antenna, and communications interfaces) and a battery. The relay device 1500 is designed for rear-entry. The sensor 1 is pushed inward from the rear of relay device 1500 against a window 1508. A plurality of gripping member 1504 retain the sensor 1 within the relay device 1500. The gripping members 1504 are sufficiently flexible to allow the sensor 1 to be pushed into place, and then return elastically to their original shape. In some embodiments, the sensor 1 has a display, and the window 1508 includes a transparent film or cover (not shown) allowing the display to be viewed.

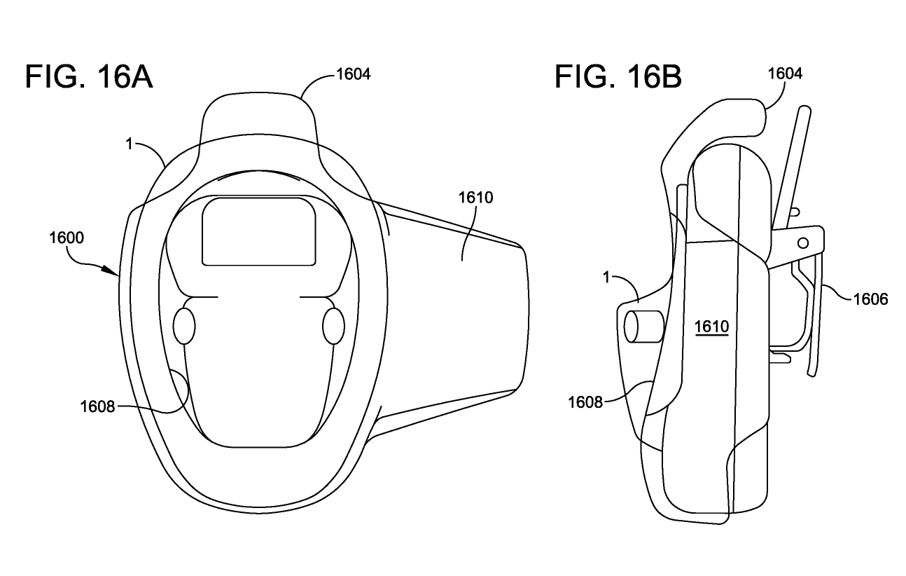

FIGS. 16A and 16B show another alternative configuration for a relay device 1600. The relay device 1600 is functionally identical to the relay device 1400, but the arrangement is different. An electronics section 1610 houses the electronics (which may include, but are not limited to, a processor, memory, an antenna, and communications interfaces) and a battery. The relay device 1600 is designed for rear-entry. The sensor 1 is pushed inward from the rear of relay device 1600 against a window 1608. A plurality of gripping member 1604 retain the sensor 1 within the relay device 1600. The gripping members 1604 are sufficiently flexible to allow the sensor 1 to be pushed into place, and then return elastically to their original shape. In some embodiments, the sensor 1 has a display, and the window 1608 includes a transparent film or cover (not shown) allowing the display to be viewed.

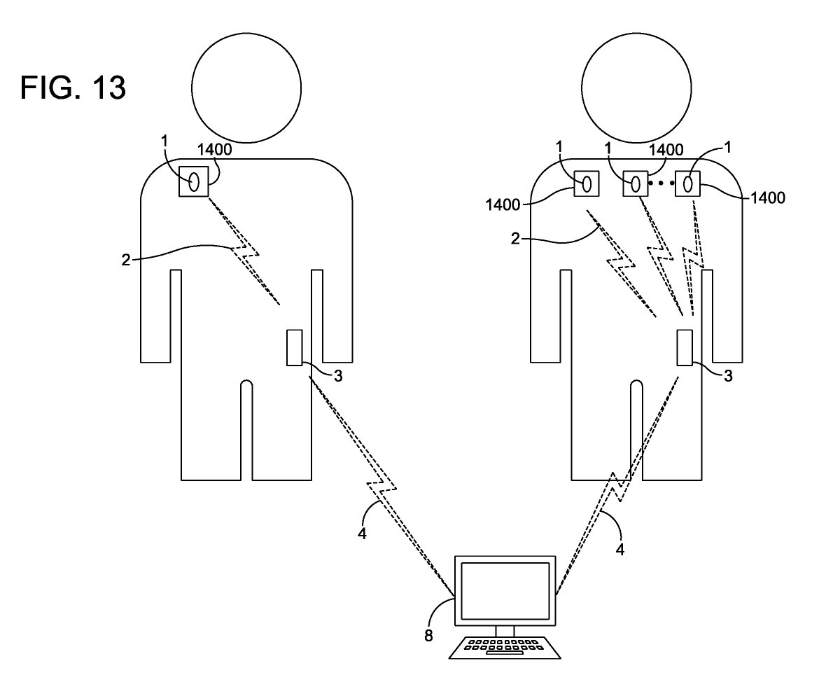

As shown in FIG. 13, both the remote sensor 1 and the main communication device 3 are paired (registered). Although FIG. 13 shows an example in which the relay device 1400 is used as a wireless gateway between the communication protocols used by the sensor 1 and the main communication device 3, other relay devices, such as relay device 1500 or 1600, can be substituted. During pairing, both devices 1 and 3 notify each other of their existence. Once paired, the remote sensor 1 will, from time to time, report to the paired main communication device 3. In addition, the main communication device 3 may request the remote sensor 1 to execute a command. The main communication device 3 will convey the data received from the remote sensor 1 to the server 6 at the control center 8 for further processing and may, from time to time, receive commands and data from the control center 8 to convey it to the remote sensor 1.

The data received from the sensor 1 by the main communication device 3 is then processed and supplemented with more information available at the main communication device 3, such as personal ID, location, acceleration or the like, and then transmitted back to the control center 8. In some embodiments, the processor (e.g., within the server 6) in the control center 8 analyzes the received data to detect the presence of an exceptional condition (e.g., the presence of a gas, such as CO), and the action or behavior of a person (e.g., an employee falling down in the presence of the detected gas, indicating an emergency condition).

In some embodiments, the server 6 analyzes the data to determine the person's behavior. For example, the server can determine if the employee is moving too quickly in an area containing hazardous gases or fragile or sensitive equipment. The server 6 can determine whether the employee is in a location that is prohibited to that specific employee.

In some embodiments, a method comprises: receiving a signal from a first device that is part of a tag, the tag adapted to be affixed to a person or any inanimate object, the receiving being performed by a processor within the tag; analyzing the signal within the processor to determine whether the person or object is performing a predetermined type of behavior; adjusting a variable rate of transmitting a monitoring signal from the tag, based on a result of the analyzing, the adjusting being controlled by the processor; and transmitting the monitoring signal from the tag to an external device separate from the tag at the adjusted variable rate.

In some embodiments, a method comprises: receiving a signal from a first device within a tag adapted to be affixed to a person or object, the receiving being performed by a processor within the tag; analyzing the received signal over a period of time within the processor to determine whether a behavior of the person or object is changing substantially over the period of time; adjusting a variable rate of transmitting a monitoring signal from the tag, based on the analyzing, the adjusting being controlled by the processor; and transmitting the monitoring signal from the tag to an external device separate from the tag at the adjusted variable rate.

In some embodiments, a method comprises: receiving a signal from a first device within a tag adapted to be affixed to a person or object, the receiving being performed by a processor within the tag; analyzing the signal within the processor to determine whether a condition is present, the condition being from the group consisting of the person or object performing a first predetermined behavior and the person or object not performing a second predetermined behavior; monitoring a location of the tag if the condition is determined to be present; and transmitting a signal representing the location from the tag to an external device separate from the tag while the condition is present.

In some embodiments, a device comprises a housing adapted to be affixed to a person or object. A first sensor in the housing is capable of generating a signal indicative of a behavior of the person or object. A second sensor in the housing is capable of collecting location data. A processor in the housing is configured for receiving the first signal from the first sensor and analyzing the signal to determine whether a condition is present. The condition is from the group consisting of the person or object performing a first predetermined behavior and the person or object not performing a second predetermined behavior. The processor is capable of controlling the second sensor to collect location data according to a schedule selected by the processor based on a result of the analyzing. A transmitter is provided for transmitting a signal representing the location from the device to an external device separate from the device according to the schedule while the condition is present.

### Sensor and Main Communication Unit

In some embodiments, a gas sensor is combined with a main communication and location device as one system. For example, the sensor 1 can be combined with a radio frequency identification (RF ID) device and (Real-Time Location System) RTLS 3. The sensor 1 transmits signals representing the sensed substance or condition. The signals are transmitted through the communication medium and is available to the central control center 8.

In some embodiments, any communication or location device 3 can be wirelessly paired with the sensor 1, and can be paired with the central control center 8 via wireless communications.

The present disclosure provides a communication device 3 such as an RTLS, and pairs it wirelessly with the sensor-detector 1. The sensor 1 either has its own short range communication interface 2, such as Bluetooth, IR or the like, or the short-range communications device can be integrated in a sleeve or holder 1400 that communicates with the main communication device (e.g., RTLS device) 3.

Once paired, the sensor 1 communicates any sensed signals to the base (the control center 8). The system can pair one sensor device 1 or plural sensor devices 1a-1c with the local communications relay device 1400. For example, several sensor detectors 1 (such as gas detectors) can be paired with a single communications device 3. In some embodiments, the sensors 1 can be different from each other. For example, different gas sensors 1a-1c can be provided for detecting H₂S, O₂, and CO, respectively. All three can be coupled to a single communication relay device 1400 or location device 3. The communication relay device 1400 or location device 3 forwards the data to the control center 8.

At least one remote, short-range communications equipped sensor/detector 1 is configured to communicate with an RF ID or RTLS communications unit 3. Multiple sensors 1a-1c can use the same personal ID/location unit 3. The personal ID/location unit 3 can have the form factor (size and shape) of a holder or holster, an employee badge, a fob, a credit card, a tag, or a wristwatch. The unit 3 can be a carrier or relay between the sensor 1 and the control center 8.

In some embodiments, the device 3 can be used in an automated safety alarm system. The main communications device 3 is integrated with an employee RF ID or RTLS system. An employee wears a location device 3, which transmits location information to the control center 8. As described below, the location device 3 provides information about motion that the control center 8 can use to determine the employee's movement and/or behavior. For example, the location device 3 can transmit location and/or acceleration information to the control center 8. If an employee is unconscious due to gas inhalation, and the location device 3 indicates a movement that is consistent with the employee falling down, the combination of location device signals and gas sensor signals can provide the control center 8 with essential information to determine the existence of an emergency condition and take action. The control center can dispatch the appropriate personnel and/or equipment more quickly.

The location device 3 adds valuable information to the output from sensors 1. The location device 3 can determine whether there is a “man down” situation, in addition to the gas sensor readings. The wireless pairing of the sensors 1 with the main communication unit 3 (location device) permits pairing with multiple sensors 1a-1c, which can be of different types.

The system described above, comprising sensors 1, a main communication device 3, and optionally a relay device 1400 can be included in a location and behavior tracking system as described below. In some embodiments, the main communication device 3 provides all the information discussed below, as used by the system to determine employee behavior.

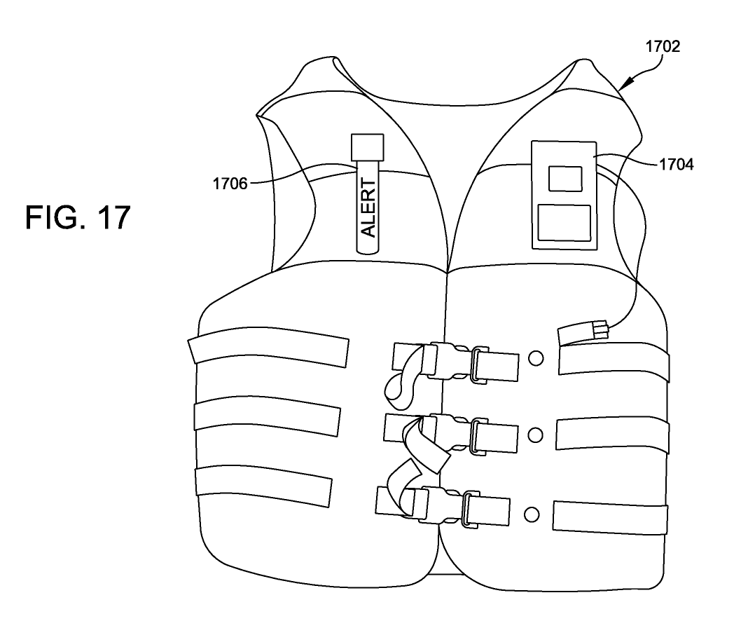

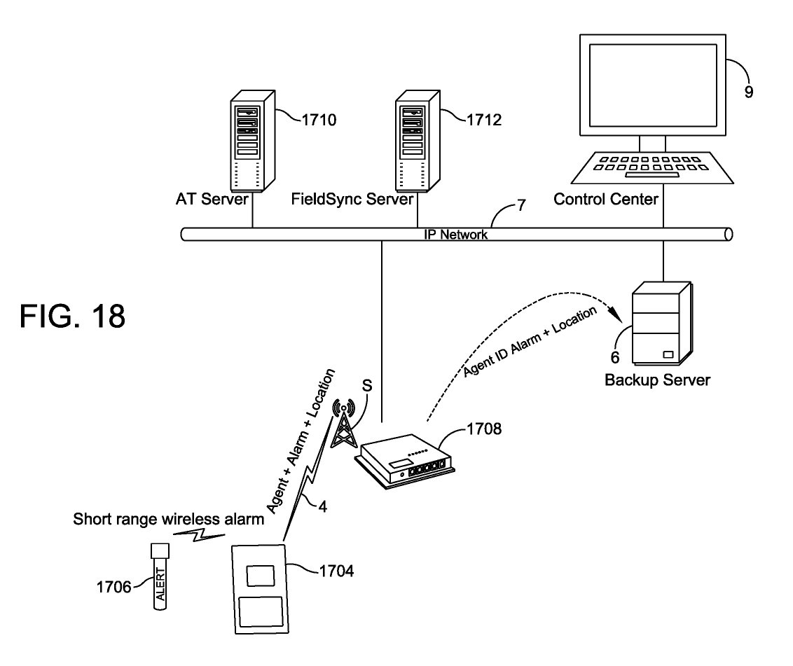

FIGS. 17 and 18 show an example of the paired sensor system according to some embodiments, attached to a safety vest (personal floatation device, PFD) 1702 to be worn by a person. In FIG. 17, the sensor 1706 is a liquid sensor capable of transmitting a radio frequency signal when the sensor 1706 is immersed in water. Such a sensor has a pair of contacts which provide an open circuit when dry, but which form a short circuit when there is water between the contacts. An example of a commercially available liquid sensor is an “ALERT2™” transmitter from Emerald Marine corporation of Seattle, Wash. The sensor 1706 transmits short range RF signals when wet.

The main communication device 1704 can be a “PRECYSETECH™” Badge Agent, sold by Precyse Technologies, Inc. of Atlanta, Ga.

The system of FIG. 17 serves as a “man overboard” detector, and can be used in a variety of marine applications (e.g., by offshore drilling platform personnel). In some embodiments, the user wears both the sensor 1706 and the main communication device 1704 on a PFD. The sensor 1706 and main communication device 1704 can be worn near the top of the PFD where the sensor can be at least partially immersed in water, but both devices are likely to still be visible. The main communication device 1704 is placed in a location where it is less likely to become immersed in water.

FIG. 18 is a schematic diagram of a system as shown in FIG. 11, in which the sensor 1706 is a liquid sensor, and the main communication device 1704 is a “PRECYSETECH™” Badge Agent, A “PRECYSETECH™” Bridge Port 1708 (sold by Precyse Technologies) can serve as a relay or repeater for transmitting signals from any main communication device 1704 within its radio field of view. The Bridge Port 1708 can act as the network's wireless routing unit and support two-way wireless communications with one or more main communication devices 1704. Some embodiments further include an iLocate server 6 (sold by Precyse Technologies) providing a unified data collection and integration platform that aggregates sensor-generated information. Some embodiments further include an iAT Server 1710 (sold by Precyse Technologies) to provide real-time visibility and process automation for multiples events and take action based on enterprise defined rules.

The sensor 1706 is responsible for detecting the actual “man overboard” event if the user falls into the water and transmits a signal alarm. The main communication device 1704 then immediately detects this alarm and then transmits it to the server 6 at the central station 8 system, along with the user's current GPS location coordinates (which are provided by the main communication device). The main communication device 1704 continues transmitting the alarm and the location until the event is canceled (e.g., by either pressing a button combination on the main communication device 1704 or by a command sent from the control center 8.

In some embodiments, The main communication device 1704 searches for a predetermined (e.g., 418 MHz) alarm signal from the sensor 1706 every few seconds (In some embodiments, the frequency and/or search interval are configurable parameters), detects the signal and generates a message that includes the alarm notification, the main communication device ID and its current GPS location. The PrecyseTech Bridge Port 1708 (sold by Precyse Technologies) covering the area receives the message and conveys it to the iLocate Server 6 (sold by Precyse Technologies) for parsing. The iLocate Server 6 also passes the data to the business application server 1710 or server 1712 for displaying and logging the alarm as well as initiating an appropriate notification and escalation process. As long as the incident continues, the Control Center display 9 will continue to show the most updated GPS location of the user in the water.

Thus, the system can detect the immersion of the sensor 1706 in water at the same time that the main communication device 3 transmits signals that are associated with a person falling. The central server can then associate the two signals to detect a man overboard emergency. For example, the server 1710 can be programmed to interpret any detection of signals from main communication device 3 indicative of falling simultaneous with or immediately preceding liquid detection signals from sensor 1704 as indicating a man overboard emergency situation.

This is just one example, and a variety of systems can be used as described herein to transmit signals identifying presence of a hazardous substance or condition (from the sensor 1) and a behavior or activity of a person wearing or holding the sensor (from main communication device 3). The combination of detecting a hazardous substance and a behavior of a person can be used as a criterion for rapid identification of an emergency requiring rapid response. The process for identification of behaviors or activities, such as falling, is described below.

### Monitoring Behavior

To ensure safety and security in the workplace, it would be desirable to know the location of all employees whose activities may impact themselves, others or property. A variety of smart tag systems have been developed which enable tracking of personnel and assets.

When tags are to be used for monitoring the location of personnel in remote locations, one of the driving factors in smart tag system design is extended battery life. It would be desirable to enable prolonged use of a tag—up to 18 months without a battery change—particularly in remote and inaccessible locations, such as deserts, offshore oil rigs, and many others.

The inventor has provided a method of extending battery life in a smart tag by selecting a location monitoring schedule based on recognition that a person or object to which the smart tag is attached is performing (or not performing) a predetermined behavior or activity, also referred to as a reference behavior.

For example, the smart tag can monitor its location (and transmit the location to a an external receiver) at a low rate, such as one report every 15 minutes, while the tag senses that it is experiencing, “ordinary” motion or ordinary lack of motion. The inventor has further found that behavior analysis can be performed locally within the smart tag with less power than is used to monitor location and/or transmit location reports. In some embodiments, when the smart tag senses that the person or object is performing a behavior (e.g., motion) having characteristics the same as, or similar to, a predetermined (reference) behavior, the location monitoring and reporting rate is increased proportionally. When the smart tag senses that the behavior has returned to “normal,” the location monitoring and reporting rate returns to the normal low rate.

As a result, the location monitoring rate can be automatically increased in proportion to how closely the detected behavior matches the predetermined behavior. Further, the increase in the location monitoring rate can be initiated as soon as the smart tag senses that an unusual behavior is being performed. The inventor has determined that undesirable events such as accidents and intentional misdeeds are more likely to occur when an employee is behaving outside of the his/her normal prescribed behavior. Thus, for example, an employee whose job normally involves sitting or walking is more likely to have an accident while running. By analyzing the employee's motion to determine whether the employee is running, the smart tag can automatically begin to monitor the employee's location when the employee runs. Should an accident occur, the system can pinpoint the employee's location, and also has a log of the employee's recent locations, from which the events leading up to the accident can be reconstructed.

In another example, an employee may work on an offshore oil drilling platform that is accessed by helicopter. The smart tag can monitor the employee's motion during normal activities, without collecting or transmitting location measurements. The smart tag can identify when the employee is likely to visit the platform by detecting a motion pattern associated with helicopter flight. Thus, when a motion pattern resembling helicopter motion is detected, the smart tag initiates (or increases the rate of) location monitoring and reporting. In some embodiments, when the helicopter motion stops (i.e., when the employee arrives on the platform), the smart tag returns to its regular low rate of reporting. In other embodiments, the monitoring continues for the duration of the employee's stay on the platform, and stops after the subsequent helicopter landing, away from the platform. That is, when a motion pattern associated with a trigger behavior is identified, the increased location monitoring and reporting continues after cessation of the trigger behavior, until after the motion pattern associated with a trigger behavior is again detected. This method of controlling the location monitoring and reporting can be used for any type of event or activity that is immediately preceded and immediately followed by a predetermined behavior.

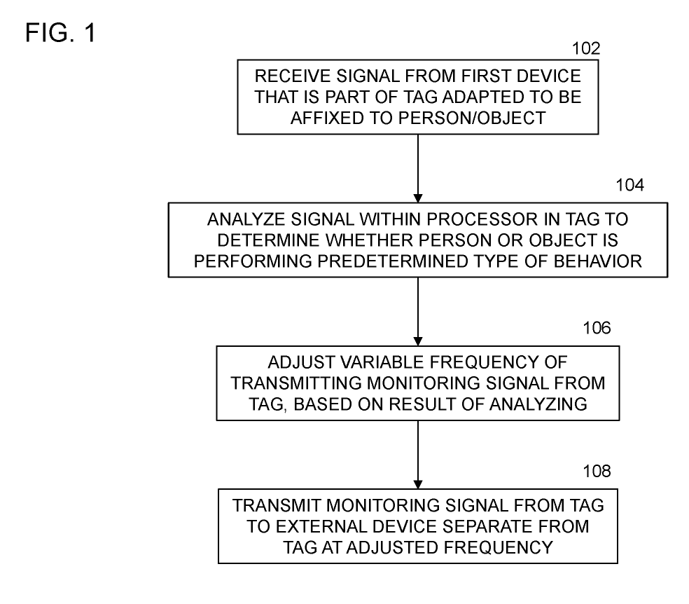

Referring to FIG. 1, an example of a method is shown.

At step 102, a processor within a smart tag receives a signal from a first device that is part of the tag. The tag is adapted to be affixed to a person or object. In some embodiments, the first device is an accelerometer.

At step 104, the processor analyzes the signal to determine whether the person or object is performing a predetermined type of behavior. In some embodiments, the processor compares the signal representing a detected motion to a signal representing a single predetermined behavior. In some embodiments, the processor compares the signal representing the detected motion to a plurality of signals representing respective a plurality of predetermined behaviors.

At step 106, the processor adjusts a variable rate of transmitting a monitoring signal from the tag, based on a result of the analyzing. The adjusting is controlled by the processor. In some embodiments, upon detection of the predetermined behavior, the location monitoring rate is increased to a fixed rate higher than the normal monitoring rate. In other embodiments, the monitoring rate can be varied continuously, based on the degree of similarity between the detected behavior and the target behavior.

At step 108, the tag transmits the monitoring signal to an external device separate from the tag at the adjusted variable rate.

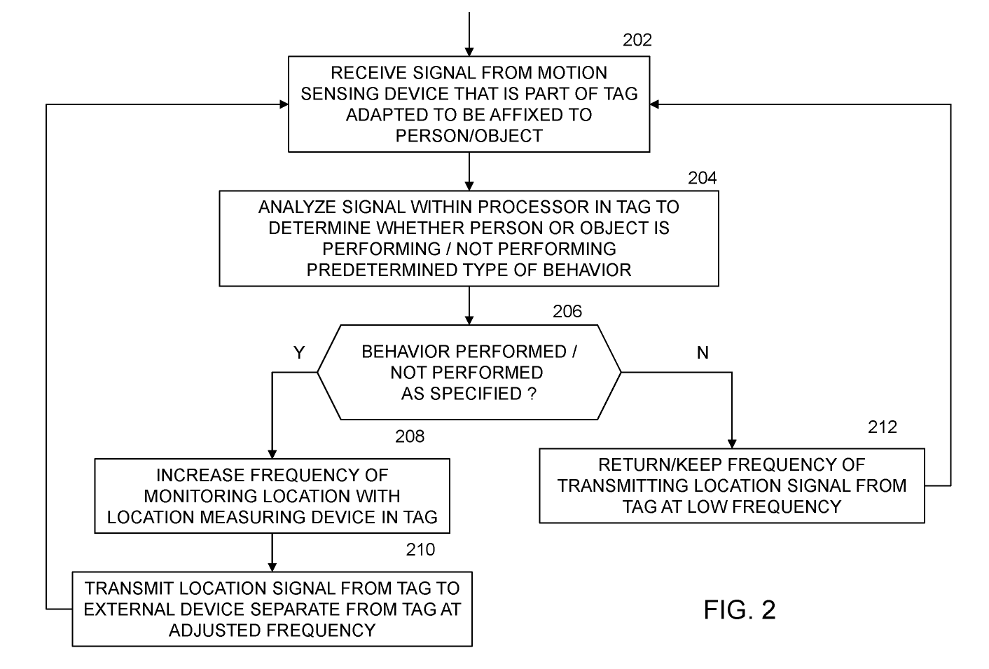

This methodology can be used in a variety of contexts and applications. For example, FIG. 2 shows an example of the method of FIG. 1, according to some embodiments.

At step 202, a processor within a smart tag receives a signal from a first device within the tag. The tag is adapted to be affixed to a person or object.

At step 204, the processor analyzes the signal to determine whether a condition is present. In some embodiments, the condition is the person or object performing a first predetermined motion. In other embodiments, the condition corresponds to the person or object not performing a second predetermined motion.

At step 206, a determination is made whether the predetermined condition is present. If the condition is present, steps 208 and 210 are performed. If the condition is not present, step 212 is performed.

At step 208, a location of the tag is monitored with increased frequency by a location monitoring device within the smart tag, if the condition is determined to be present.

At step 210, a signal representing the location is transmitted from the tag to an external device separate from the tag while the condition is present. At the completion of step 210, the loop beginning at step 202 is repeated.

At step 212, if the predetermined (motion) condition is not present, and the location monitoring rate is set at a high rate, the location monitoring rate is returned to its normal low rate. If the predetermined (motion) condition is not present, and the location monitoring rate is set at its normal low rate, the location monitoring rate remains at its normal low rate.

In various embodiments, a variety of methods are used to determine the location monitoring rate. In one embodiment, a single predetermined behavior is identified. The location monitoring rate is normally low. While the behavior is detected, the location monitoring rate is set at a predetermined high. When the predetermined behavior is discontinued, the monitoring rate returns to the normal low rate.

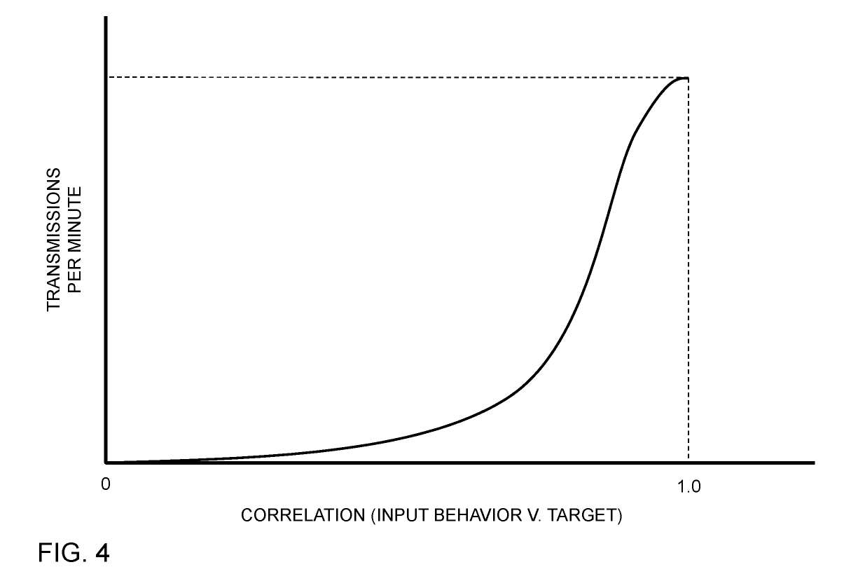

In other embodiments, the processor computes a measure of how closely the current motion behavior resembles the predetermined behavior. The closer the current behavior is to the predetermined behavior, the higher the location monitoring frequency. In some embodiments, the analyzing includes computing a measure of how closely the received signal resembles a signal corresponding to the person or object performing the predetermined motion and determining the variable rate as a monotonically increasing function of the computed measure. For example, FIG. 4 shows an example of a location monitoring and transmission rate as a function of the correlation between the measured input motion behavior and the predetermined motion behavior. The higher the correlation, the higher the monitoring frequency. The monitoring frequency can be adjusted one time or many times while the behavior is being performed.

In other embodiments (not shown), the control device includes a fuzzy logic module that determines the degree to which a given input signal from the motion sensor conforms to any one or more predetermined behavior patterns. The fuzzy logic module selects a monitoring frequency by combining the results from each of the comparisons made. For example, the control device may contain fuzzy logic membership functions entitled, walking slowly, walking normally and walking quickly, which have overlapping velocity ranges and/or overlapping ranges of steps-per-minute. The controller can decrease, maintain, or increase the rate of location measurement and reporting based on the respective truth value indicating the likelihood that the output of the motion sensor corresponds to each of these three behaviors.

In other embodiments, the system is programmed to adopt location monitoring rates for one or more discrete predetermined activities or behaviors. An input behavior can be identified. Depending on which predetermined behavior(s) are selected to initiate monitoring, any given input behavior may initiate a different predetermined level of monitoring.

The first device (e.g., a motion sensor such as an accelerometer) is capable of transmitting respectively different signal patterns corresponding to respectively different types of motion. When the processor receives the signal pattern output by the first device (motion sensor), the processor compares the signal to one or more templates corresponding to predetermined behaviors. The processor is programmed to recognize at least one predetermined signal pattern as representing a performance of the predetermined type of motion by the person or object.

In some embodiments, the adjusting includes increasing the variable rate when the at least one predetermined signal pattern is recognized. In other embodiments, the adjusting includes increasing the variable rate when the signal is not recognized as corresponding to the at least one predetermined signal pattern. Thus the predetermined condition can be performance of a prohibited behavior or failure to perform a required behavior.

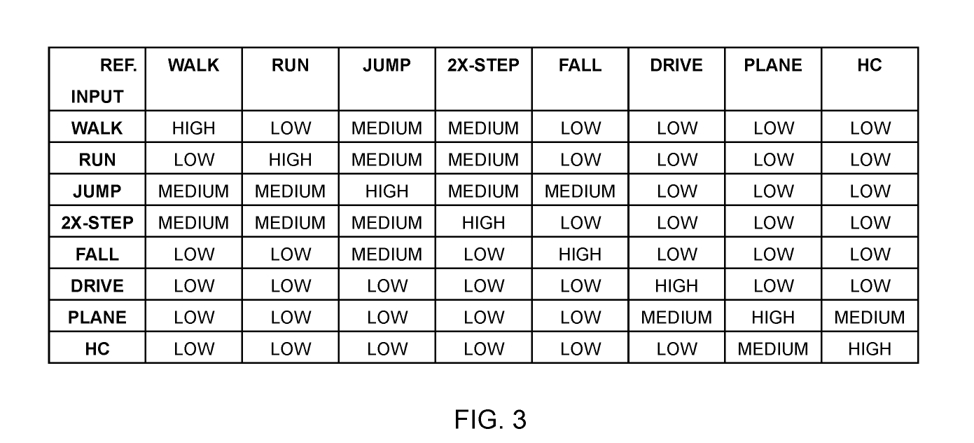

FIG. 3 is an example of a table stored in a non-transitory storage medium in the tag, defining the location monitoring frequency to be used, based on the predetermined reference activity or event (top row) and the input behavior sensed by the motion sensing device. A plurality of predetermined behaviors and their signature signals are identified to the system. These predetermined behaviors can include walking, running, jumping, descending (or ascending) stairs two steps at a time, falling, driving, flying in a plane, or flying in a helicopter. The similarity of each predetermined behavior to each other predetermined behavior can be determined (either manually by a user, or automatically by computing the correlation of the motion sensor outputs associated with each predetermined behavior. These similarity values are associated with location monitoring and reporting rates. for example, if the predetermined behavior is running, and the input behavior is running, the exact predetermined behavior has been detected, and the table indicates that the location monitoring is to be set to a high rate. If the predetermined behavior is running, and the input behavior is jumping or descending two steps at a time, an input behavior similar to the predetermined behavior has been detected, and the table indicates that the location monitoring is to be set to a medium rate. If the predetermined behavior is running, and the input behavior is falling, driving, or flying in a plane or helicopter, the detected behavior is not similar to the predetermined behavior, and the table indicates that the location monitoring is to be set to a low rate.

In some embodiments, the monitoring signal is the signal received from the first device. That is, the behavior is sensed by a device capable of generating an output signal indicating location, such as a high efficiency gyro. In other embodiments, the monitoring signal is a signal received from a second device, and transmitting signals from the second device uses more power than transmitting signals from the first device. For example, the person or object's behavior can be sensed with an accelerometer (which measures acceleration), and the location can be sensed with a second sensor, such as a gyro, GPS receiver, or RF transceiver (for communicating with a plurality of radio frequency (RF) beacons.

In some embodiment, the condition for each individual smart tag is selected before the tag is entered into service monitoring the person or object's behavior. In some embodiments, the system administrator can individually select the predetermined behavior for each employee's tag, based on a job position of the person. Thus, for an airplane pilot, the signal associated with plane flight is not an event that would cause increased monitoring of the employee's location, but the signal associated with helicopter flight can be such an event.

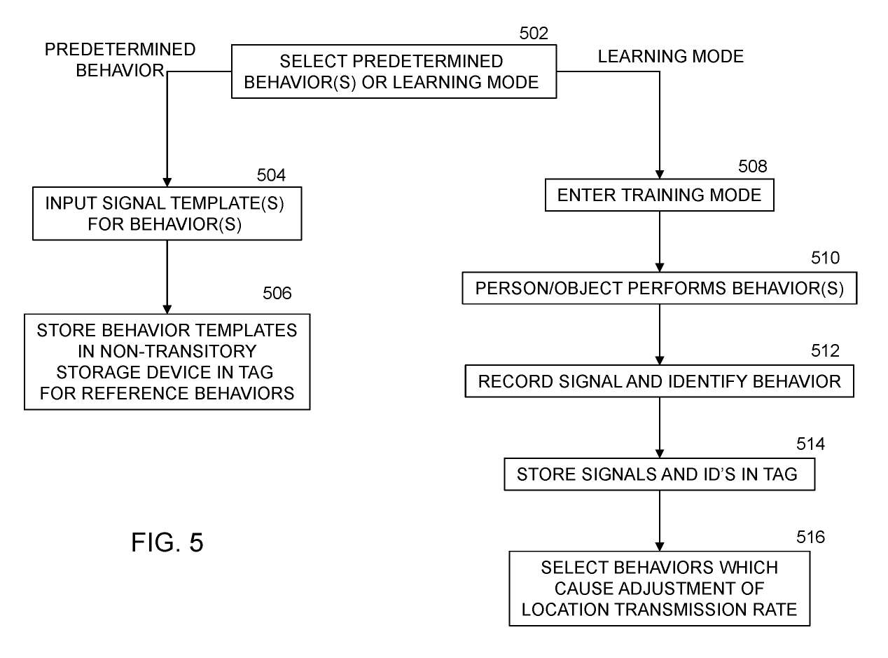

FIG. 5 shows a method of configuring the controller in one of two modes.

At step 502, in some embodiments, the user is given the option of selecting one of two different operating modes: a predetermined behavior mode or a learning mode. This can be input by actuating a switch on the tag, for example.

At step 504, if the tag is operating in the predetermined behavior mode, the system administrator inputs one or more signal templates for the predetermined behavior(s). In some embodiments, the templates resemble the raw output signal of the motion sensor (e.g., accelerometer). This may reduce any transformation of the input signal needed to compare the input to the predetermined behavior signature signal. In other embodiments, the sensor output is to be transformed before comparison to the template.

At step 506, the behavior templates are stored in a non-transitory storage device in the tag for later use as predetermined behaviors, to which input behaviors are to be compared.

At step 508, the tag is placed in learning mode. In the learning mode, the tag records and analyzes the output signals from the sensor during a training period, and builds its own behavior templates.

At step 510, with the training mode initiated, the person is instructed to perform one or more predetermined behavior(s). Thus, the person may be instructed to walk, run, jump, climb steps, two at a time, fall, drive, or the like.

At step 512, the controller samples and records the sensor output signal while the person or object performs one or more predetermined motions. The behavior(s) is (are) identified. In some embodiments, the identification involves labeling the recorded profile as corresponding to the type of motion the person was instructed to perform.

At step 514, the controller stores a representation of the at least one predetermined motion pattern in a storage device within the tag. (Subsequently, when behavior is monitored, the analyzing includes comparing the sampled signal to the received signal.

At step 516, if multiple behaviors have been sampled and stored in the tag, the system administrator can select a subset of the stored behaviors to be used as reference behaviors during operation. Subsequently, during operation, the analyzing step includes comparing the sampled signal to the received signal.

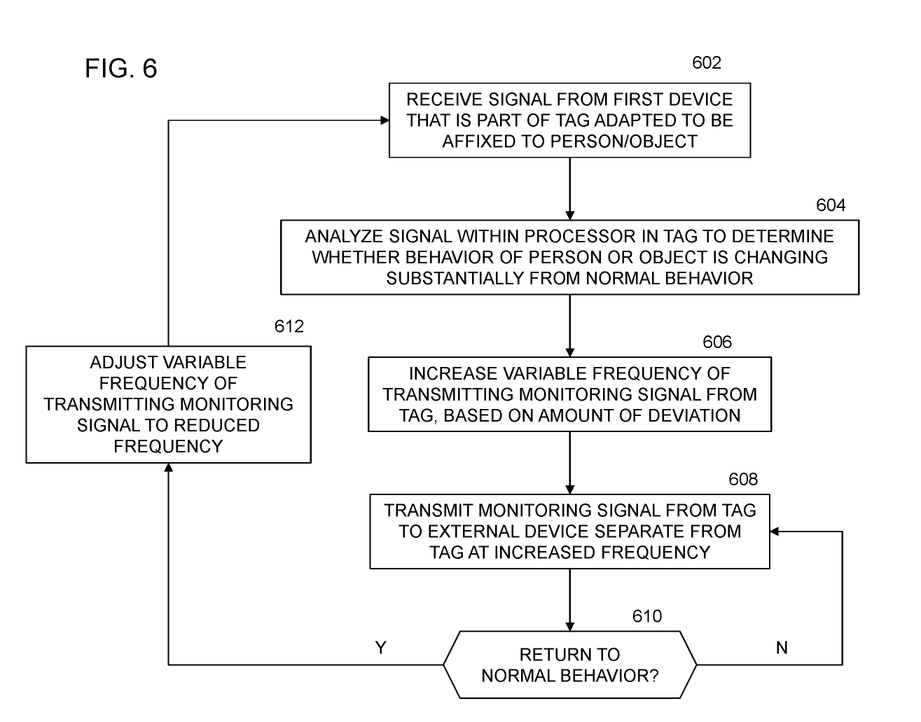

FIG. 6 is a flow chart of another variation of the method.

At step 602, a processor in a smart tag receives a signal from a first device within the tag. The tag is adapted to be affixed to a person or object.

At step 604, the processor within or on the tag analyzes the received signal over a period of time to determine whether a motion behavior of the person or object is changing substantially over the period of time. For example, a Kalman filter can be used to determine the normal behavior based on the signals received from the motion sensor, and to determine whether the the a posteriori state estimate deviates substantially from the a priori state estimate. In some embodiments, the processor runs a neural network algorithm to self-train the system, based on activity during a training period.

At step 606, the processor adjusts a variable rate of transmitting a monitoring signal from the tag, based on the analyzing. The variable rate is adjusted by an amount that increases monotonically as a function of a magnitude of the changing. Thus, the system can respond to any sudden change in behavior by increasing the rate of monitoring, without a priori knowledge of what the behavior will be.

At step 608, the tag transmits the monitoring signal from the tag to an external device separate from the tag at the adjusted variable rate.

At step 610, a determination is made whether the motion detected by the sensor in the tag has returned to the normal motion pattern. If the system has returned to the normal behavior, the step 612 is performed. If the system has not returned to the normal behavior, the step 610 is performed.

At step 612, the processor in the tag adjusts the variable rate of transmitting a monitoring signal from the tag, based on the analyzing to return to the lower normal rate.

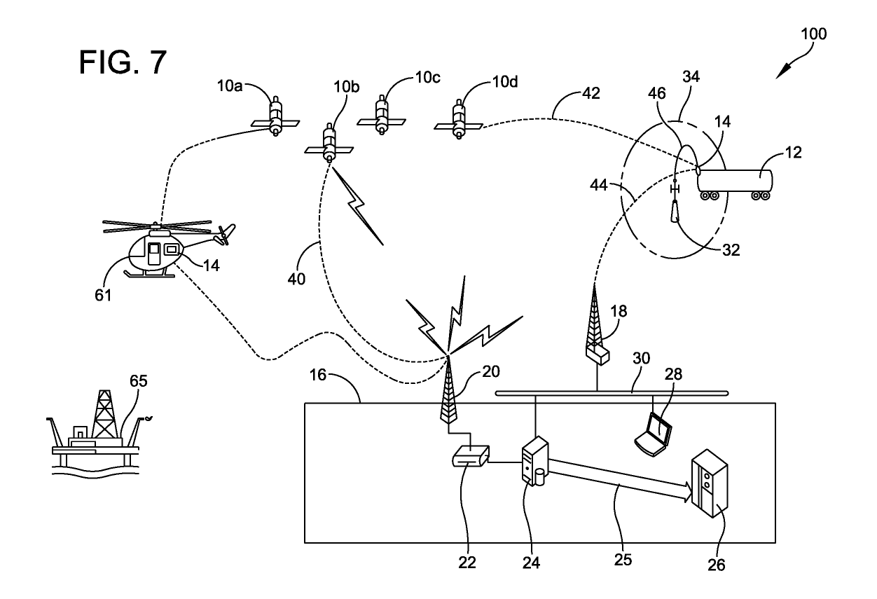

Reference is now made to FIG. 7, schematically illustrating a block diagram of a smart tag system 100 according to an exemplary embodiment. FIG. 7 provides an example in which the smart tag 14 is used with an assisted GPS (AGPS) system. In other embodiments, the method described herein using motion behavior to initiate an adjustment of the rate of location monitoring and reporting can be performed in a GPS system without assisted data.

As seen in FIG. 7, the system 100 comprises a service center 16, a ground base station 18, a beacon 32, and a smart tag 14 adapted to releasably affix to a person or object of interest 12. The ground base station 18 is connected to the service center 16 via IP network 30. The service center 16 further comprises a central processing server 24, a customer application server 26 connected to the central processing server 24 via a application programming interface 25, and stationary GPS receiver 22 furnished with an antenna 20. The receiver 22 and the smart tag 14 are adapted for to receive signals broadcasted by satellites 10a . . . 10d via wireless communication channels 40 and 42, respectively. The ground base station 18 is adapted to wirelessly RF-communicate with the smart tag 14 via a channel 44. The stationary GPS receiver 22 furnished with the antenna 20 is adapted to search for and receive signals broadcasted by the satellites available for receiving. As seen in FIG. 7, the beacon device 32 has a service zone 34.

In some embodiments, the smart tag 14 affixed to a person or object of interest 12 is situated in the service zone 34 of the beacon device 32. The smart tag 14 is woken up by either itself when sensing predefined conditions or events (such as motion or time elapsed) or a command sent from the service center 16. Being woken up, for example, by the service center 16, the smart tag 14 receives a signal from the beacon device 32 via wireless communication channel 46. The aforesaid signal carries ID data of this specific beacon 32. The smart tag 14 measures parameters of the beacon signal and derives the beacon ID data. Further the beacon 32 retransmits the received beacon ID and signal measurement data to the service center 16. The beacon ID data enables the service center 16 to determine an approximate location of the smart tag 14 and provide the smart tag 14 with assisted data. This data is generated according to satellite-broadcasted signals receivable by the stationary reference GPS receiver 22.

As discussed above, providing the smart tag 14 with assisted data enables the system 100 to reduce energy consumption due to shortening TTFF (acquisition assistance) and more reliable reception (sensitivity assistance) for use in indoor conditions.

The smart tag 14 performs signal search according to the received assisted data, receives satellite-broadcasted signals and calculates pseudo-ranges from the tag 14 to the available satellites 10a, 10b, 10c, and 10d. The calculated pseudo-ranges are transmitted to the service center 16 for further processing. The central processing server 24 is adapted to calculate a location of the smart tag 14 by means of triangulating the obtained pseudo-ranges.

Reduced power consumption comes about because the smart tag 14 is in standby condition and is woken up for a short time on demand.

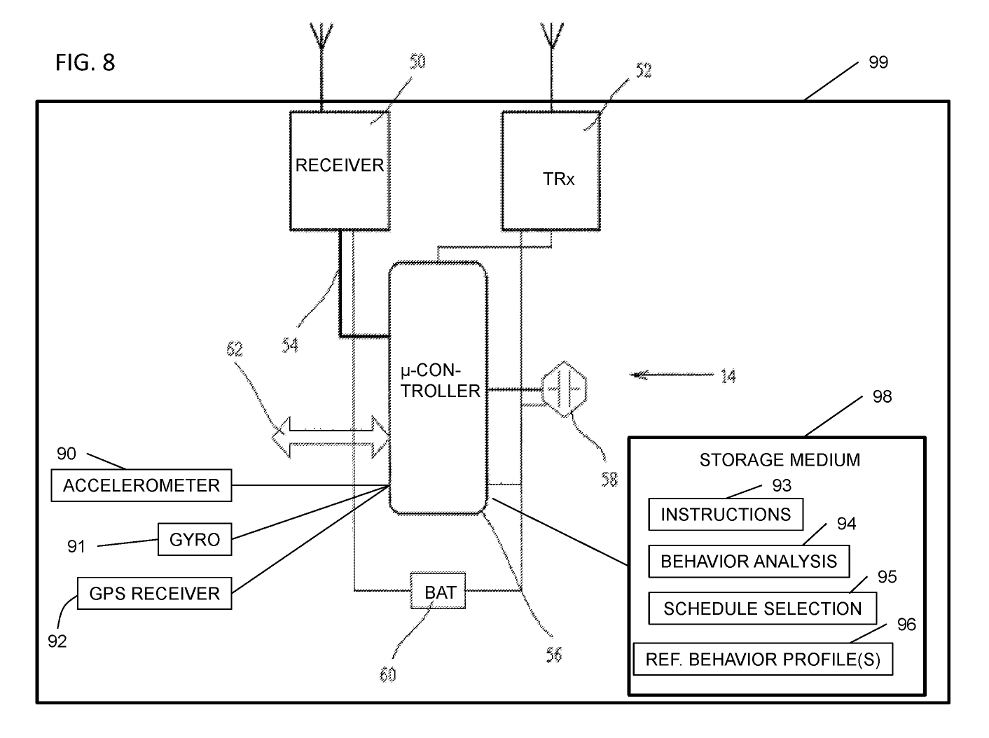

Reference is now is made to FIG. 8, presenting a block diagram of the smart tag 14. The smart tag has a housing 99 adapted to be affixed to a person or object. The smart tag 14 may comprise a standard GPS receiver (or an AGPS receiver) 50, an RF-transceiver 52, a data bus 54, a microcontroller unit 56, a motion sensor 58, a battery 60, and I/O port 62. In some embodiments, the motion sensor 58 is an accelerometer. In other embodiments, the motion sensor 58 is a gyro, and a separate sensor 90 is provided. The sensor 58 or 90 in the housing 99 is capable of detecting motion and generating a first signal characterizing the motion;

A second sensor is capable of collecting location data. In some embodiments, the second sensor is a gyro 91. In other embodiments, the second sensor is a GPS receiver 92. In other embodiments, the second sensor is an RF transceiver in communication with RF beacons 32.

The tag 14 has at least one non-transitory storage medium 98, such as a flash memory, containing general operating computer program instructions 93, behavior analysis instructions 94, schedule selection instructions 95, and reference behavior profiles/templates 96.

The processor 56 (which can be a microcontroller) in the housing 99, is configured for receiving a first signal from the first (motion) sensor and analyzing the signal to determine whether a condition is present. The condition is one of the group consisting of the person or object performing a first predetermined motion and the person or object not performing a second predetermined motion, the processor capable of controlling the second sensor to collect location data according to a schedule selected by the processor based on a result of the analyzing. A transmitter is provided for transmitting a signal representing the location from the device to an external device separate from the device according to the schedule while the condition is present. In some embodiment, the transceiver 52 provides the transmitter for transmitting the location data.

As discussed above, the smart tag 14 can be in standby condition by default. The tag is woken up by either itself when sensing predefined events (such as motion or time elapsed) or a command sent from the service center 16 via the wireless RF-communication channel 44. The transceiver 52 receives a signal from the beacon device 32 via wireless communication channel 46. The aforesaid signal carries ID data of the specific beacon 32. The microcontroller 56 measures signal parameters and derives the beacon ID data. Optionally, a received signal strength indicator and a phase delay or any combination thereof are measured by microcontroller 56.

Further, the transceiver 52 retransmits the received beacon ID and signal measurement data to the service center 16. The beacon ID data enables the service center 16 (not shown) to determine an approximate location of the smart tag 14, generate the assisted data, and provide the smart tag 14 with the approximate location and the assisted data.

Being provided with assisted data, the AGPS receiver 50 searches and receives the satellite-broadcasted signals. The pseudo-random waveform received by GPS receiver 50 is compared with an internally generated version of the same code with delay control, until both waveforms are synchronized. The obtained delay of internal pseudo-random form corresponding to the waveform synchronization defines the travel time of the GPS signal from the satellite to the receiver 50. The obtained delay values are provided via the data bus 54 to the microcontroller unit 56. The delay values (pseudo-ranges) further are transferred to the service center 16 via an RF-communication link 44 for calculating the smart tag location. Thereafter, the smart tag 14 restores to the standby condition.

The smart tag 14 is a mobile battery-powered device. Therefore, the methods described herein secure a long battery service life. The smart tag 14 further comprises a motion sensor 58 enabling the service center to assist tracking the smart tag 14 outside the service area. I/O port 62 provides a connection of peripheral devices (not shown) to the smart tag 14 and two-way data interchange between the aforesaid device and the service center 16.

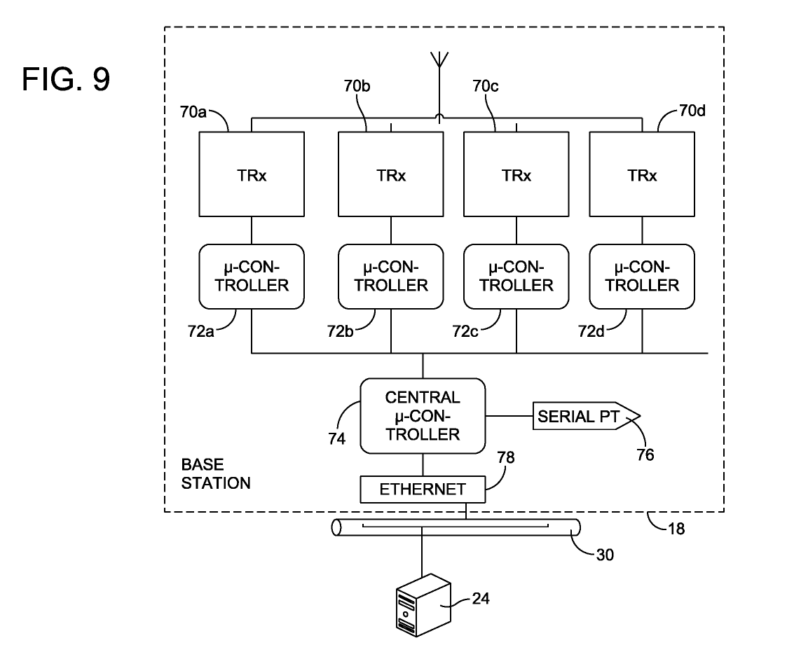

Reference is now made to FIG. 9, schematically illustrating a block diagram of the architecture of the ground base station 18. The aforesaid base station 18 is a ground communication unit communicating with the plurality of mobile smart tags via wireless communication links.

The base station 18 comprises four independent RF transceiver modules 70a, 70b, 70e, and 70d (rack transceiver) operating simultaneously. The rack transceiver is required for supporting the frequency diversity mode of operation, providing the required capabilities for withstanding external interferences. Microcontroller units 72a, 72b, 72c, and 72d perform management of the data stream in transceivers 70a, 70b, 70e, and 70d, respectively.

A central microcontroller unit 74 is responsible for activating and controlling internal operational logic of the base station 18. A serial port 76 connects peripheral devices to the base station 18. As seen in FIG. 9, the base station 18 further comprises Ethernet chipset 78 for connecting to the Ethernet 30. The base station 18 is controlled by central processing server 24 via the Ethernet connection 30.

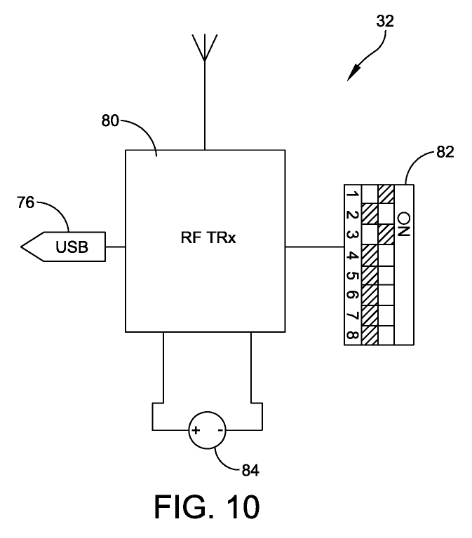

Reference is now made to FIG. 10, presenting a block diagram of the AC/DC (84)-powered beacon device 32 comprising an RF-transceiver 80 capable of transmitting beacon device ID data at the predetermined frequency and time. The beacon device 32 is furnished with an attenuator 82 and the serial or USB port 76 enabling the service center to change over the air a level of emitted power and configuring and maintaining the beacon device 32, respectively.

In the examples discussed above, the reference behaviors include motion (or lack of motion). In other embodiments, the reference behavior is entering a distinctive ambient, and the tag has a sensor for sensing the ambient condition, such as ambient temperature, barometric pressure, humidity, or a sensor capable of detecting any particular gas (e.g., natural gas or carbon monoxide). Such a tag may be useful if it is desirable to frequently monitor activity at a location that has a distinctive ambient. For example, if it is desirable to monitor any activity in a desert, an ambient temperature or humidity sensor can transmit signals that are analyzed by a processor within the tag; the processor can then increase the location monitoring and reporting rate by the tag if the subject enters an extremely hot or extremely dry ambient. (The rate can be proportional to the temperature increase beyond normal work environment temperature, or proportional to the humidity decrease below normal work environment humidity) When the sensor detects that the ambient temperature and humidity have returned to normal, the processor reduces the location monitoring and reporting rate by the tag to the normal rate.

In other embodiments, the first device senses a body parameter, such as temperature, heart rate, blood pressure, blood alcohol content or the like which is indicative of behavior. Such parameters involve correspondingly different types of sensors, which can be invasive or non-invasive, depending on the parameter to be monitored. For example, an employee who performs a task involving public safety may be required to periodically breathe into a breathalyzer. The processor in the tag can adjust the location monitoring and reporting rate to an increased rate in proportion to the blood alcohol content; or increase the monitoring and reporting rate to an increased rate in proportion to a length of time in which the employee has not breathed into the breathalyzer (based on the assumption that an employee who has been drinking is likely to avoid breathing into the breathalyzer). The processor in the tag can return the location monitoring and reporting rate to normal when the employee resumes regular use of the breathalyzer with zero or low blood alcohol content. In another example, an employee who handles delicate objects may be prohibited from running while at work. A sensor can sense the employee's heart rate, which is likely to be significantly elevated if the employee has been running. The processor in the tag can adjust the rate of monitoring and reporting location based on the detected heart rate.

Thus, the first device can be any of a wide variety of sensors which detect a condition that correlated with the subject's behavior or location. The processor in the tag can analyze the signals from the sensor and correlate the frequency of location monitoring and reporting to the behavior. This permits the tag to lower power consumption when the reference behavior is not being performed and increase the battery life, without compromising the location log during times when the reference behavior is being performed.

This disclosure provides a method for automatically alerting personnel or any other object of interest when that person or object enters a Hazardous Area.

For example, in some embodiments, if a gas leak is detected in a certain area, the system alerts an employee who enters the hazardous area. The alert can range from a simple alarm to a specific message or instruction telling the employee to stay away or use a special tools to avoid injuries.

In some embodiments, the method comprises the following steps:

(1) Hazardous Event Detection and reporting.

(2) Creating Hazardous Area Descriptors

(3) Broadcasting HAD list to be received by the mobile location/alerting device.

(4) Acquiring a current mobile device location and comparing it to the HAD list

(5) Raising an alert if the current location is within one of the reported Hazardous Areas.

In the step #1, one or more environmental parameters (or other parameters of interest) are measured by any available detectors having wired or wireless communication capabilities. For example, the detectors can include a carbon monoxide (CO) or carbon dioxide (CO2) sensor. Each detector can have a respective predefined safe range or predefined limit. If any monitored parameter has a value outside its safe range or exceeding its predefined limit, the detector will send the event notification along with the location (if not known already) to a remote server for further processing

In step #2, the remote server processes the data and creates an HAD (Hazardous Area Descriptor) for the specific alerting detector. The HAD may contain, among other parameters: the location coordinates of the HA (Hazardous Area) center and the HA radius. In some embodiments, the HA radius is a fixed predefined distance for each type of sensor. In other embodiments, the HA radius is computed by detector, based on its current value. In other embodiments, the HA radius is computed by the remote server, based on the most current value received from the detector. The remote server enters the newly created HAD into the currently available HAD list.

In step #3, the remote server broadcasts the entire list to all the mobile communication devices available on the network. In some embodiments, the list is broadcasted continuously, so any new mobile device, signing up to the network, receives it immediately. In other embodiments, the list is broadcast periodically, with a short delay (e.g., 0.5 sec., 1.0 sec., or 1.5 sec.) between successive broadcasts. Each broadcast of the HAD list is given a unique ID, which is included within the transmission. When each detector receives and is updated with the new HAD record, this HAD ID changes to allow mobile devices to detect the new list being broadcasted and hence receive and update its internal copy of the HAD list.

In step #4, the mobile location/alerting device periodically (or on demand) acquires its current location. In some embodiments, the mobile device is equipped with a GPS receiver. In some embodiments, the mobile device uses assisted GPS. In other embodiments, the mobile device uses another mechanism for determining its location, such as triangulation based on the strength of signals received from a plurality of beacons or signal sources. In some embodiments, the mobile device location can be determined using the methods described in U.S. Patent Application Publication No. US 2011/0159888 A1. Once acquired, the processor in the detector locally compares this location to the most recently received HAD list. If the location of the detector is within the respective HA radius from the HA center of one of the HAs on the HAD list, then the processor determines that the mobile device is within an HA.

Other methods can be used to determine whether the mobile device is within the HA. For example, in some embodiments, given an HA center X₀, Y₀, the x and y coordinates of the mobile device are checked to determine whether they satisfy the inequaltiies (X₀,−C₁)<x<(X₀,+C₁) and (Y₀−C₂)<y<(Y+C₂), where C₁ and C₂ are constants. If both X₀, and Y₀ fall within these ranges, then the location x, y is within a rectangle having a center at X₀, Y₀, and is considered to be within an HA.

The determination of whether or not the mobile device resides in an HA, is performed locally in the device and does not require any communication with the remote server.

In step #5, if the current location found “inside” one of the locally listed HAs, the alert will be immediately raised. In some embodiments, the detector has a built-in alert device within the housing of the detector, for issuing an auditory and/or visual alert. In other embodiments, the detector is in wired or wireless communication with an alert device local to the detector (e.g., an alert device in the employee's badge); the alert device generates the auditory and/or visual alert in response to a signal from the detector. In other embodiments, fixed-location alert devices are placed at various locations in the facility, and when the detector determines that it is within the HA radius of the center of one of the HAs on the list, the detector transmits a trigger signal to the nearest fixed-location alert device.

In some embodiments, a user carries a communication device with a location detection apparatus. For example, the user may have an employee badge with a processor, a GPS receiver, a wireless transceiver and antenna capable of communicating with the remote server, and a local communications adapter for communicating with one or more detectors. Each detector includes a sensor for detecting a hazardous condition (e.g., a CO sensor) and a transceiver and antenna for communicating with the employee badge (e.g., using a personal area network protocol). The employee badge can process the outputs from the detector(s), and notify the remote server if one of the detectors detects a hazardous condition. Upon receiving an updated list from the remote server, any of the location detection apparatuses can determine if they are located within one of the currently listed HADs and initiate an alarm.

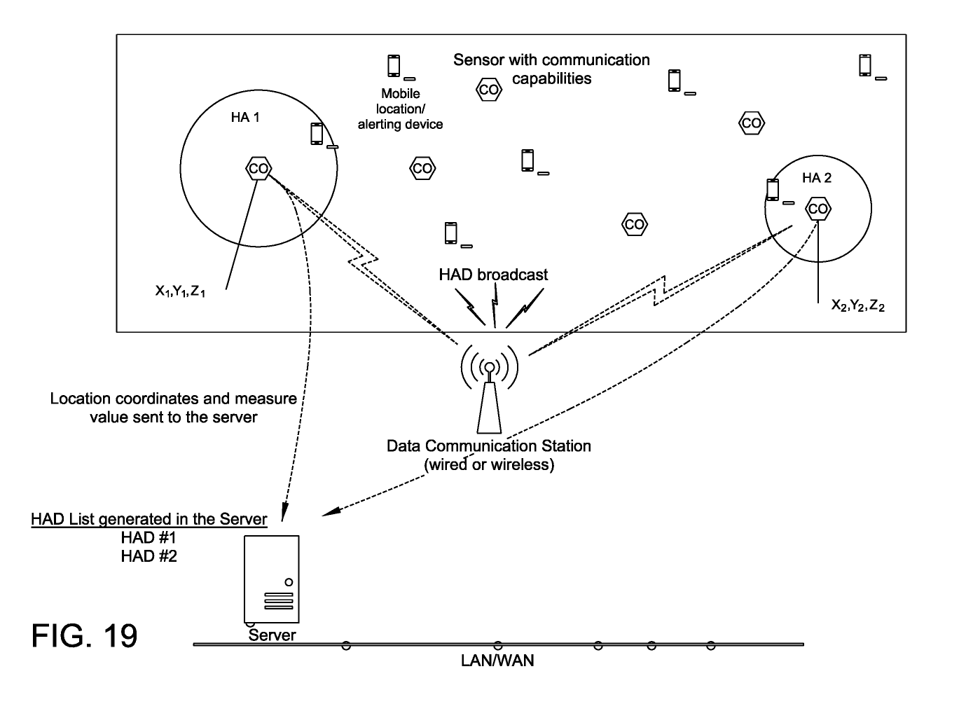

FIG. 19 is a schematic diagram of an example of a system. A plurality of mobile devices are provided, each equipped with a location device and an alerting device. In some embodiments, the mobile device is unitary. The system also includes a plurality of detectors (sensors). In some embodiments, the detectors have wired or wireless communications capability for communicating with the mobile devices. In some embodiments, the detectors communicate with the mobile devices in the manner described above. FIG. 19 shows CO sensors, but other embodiments include other types of sensors.

The system has a remote server which is connected via a wired or wireless local area network (LAN) or wide area network (WAN). In other embodiments, at least one of the mobile devices and one of the sensors are integrated into the same housing.

The server is also in wired or wireless communication with a data communication station. The data communication station is configured with a transceiver and antenna, for broadcasting the current HAD list to all mobile devices within receiving range of the data communication station.

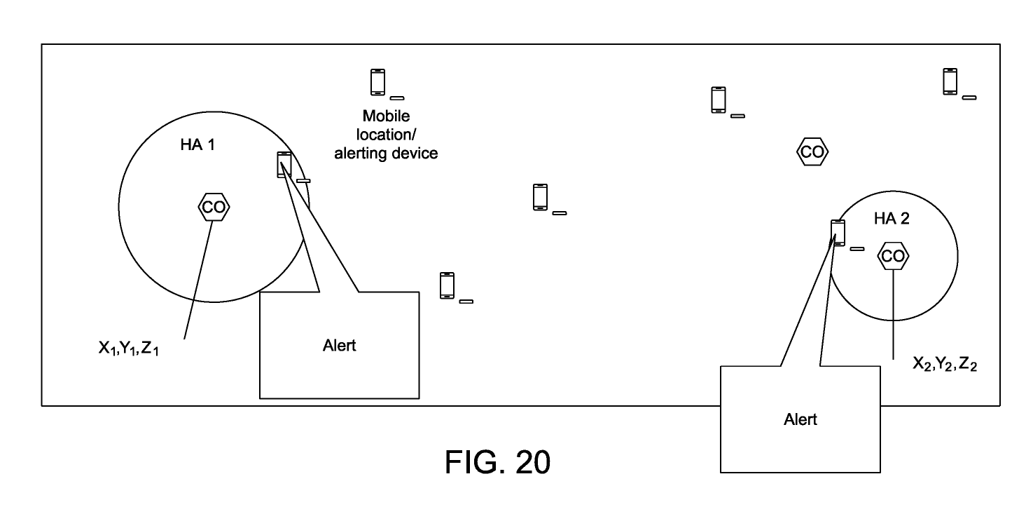

As shown in FIG. 20, two of the CO sensors located in HA1 and HA2, respectively, detect hazardous conditions (e.g., excessive levels of CO). Each of the sensors in regions HA1 and HA2 transmits a signal with HA descriptor data to the remote server. At a minimum, the sensors transmit signals to the server identifying their locations. In some embodiments, the sensor signals also include a quantitative measure of the condition detected, such as the concentration of CO. In some embodiments, the sensor signals identify an HA radius, such that any location within a distance of the HA radius to that sensor is considered hazardous. The remote server adds the HA descriptor data from HA1 and HA2 to its list of the HAs. The remote server then continuously or periodically transmits its HAD list to the Data communication station, which in turn broadcasts the HAD list to all of the mobile devices within communications range of the data communication station. The mobile devices store the HAD list in their local memories. The mobile device continuously or periodically compares its location to the locations in the HAD list. Upon entry by one of the mobile devices in one of the HAs, the mobile device recognizes that it's current location is within one of the HAs, and the mobile device initiates an alert. In some embodiments, the alert is provided by an alarm internal to the mobile device.

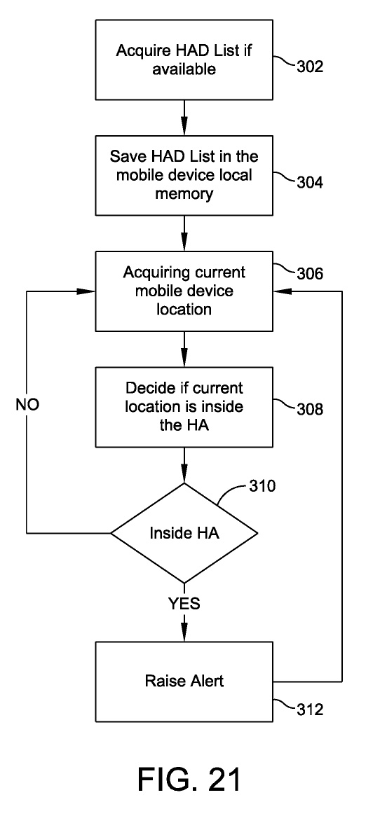

FIG. 21 is a flow chart of a method of using the system, as performed by a mobile device/sensor pair or integrated mobile device equipped with a sensor.

At step 302, a mobile device acquires the HAD list from the remote server. The mobile device compares the HAD list ID of the currently received list to the HAD list ID of the HAD list stored in the local memory of the local device. If the two HAD list IDs are different, then the HAD list received from the remote server is an updated list. The mobile will always update the entire HAD list once it determines that the remote server has broadcast a new HAD List ID. Thus, all additions to and deletions from the HAD list are reflected in the updated local copy in the mobile device.

At step 304, the mobile device saves the HAD List in the local memory of the mobile device.

At steps 306 to 312, a loop is repeated continuously or periodically.

At step 306, the mobile device acquires its current location, using (unassisted or assisted) GPS, triangulation using signals from beacons, a colliding signals method or the like.

At step 308, the mobile device determines whether its current location is inside an HA. For example, if the HAD is specified by a radius, then the mobile device computes the Euclidean distance between the mobile device and the center of the HA. If the mobile distance is less than the radius, then the mobile device is within the HA.

At step 310, if the mobile device is not inside any of the HAs, the processor in the mobile device jumps to step 306. If the mobile device is inside any of the HAs, the processor in the mobile device continues to step 312.

At step 312, the mobile device initiates an alert. The alert can be visual or auditory. The alert can be issued by an alert device in the mobile device, an alert device in the sensor, or by a separate alert device in communication with the mobile device. The program then returns to step 306.

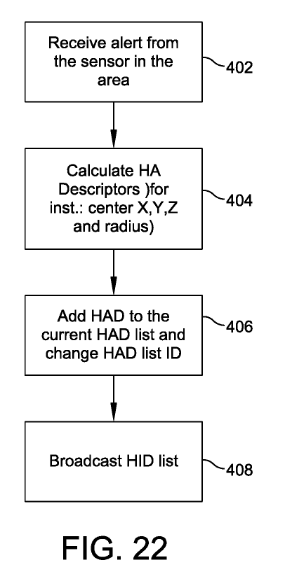

FIG. 22 shows an example of a method performed by the server.

At step 402, the remote server receives an alert from one of the sensors.

At step 404, the remote server calculates HA descriptors. For example, if the sensor provides a location and concentration of CO, the server can compute a distance from the sensor, within which the concentration of CO is expected to be unsafe.

At step 406, the server adds the HAD to the current HAD list and changes the HAD list ID. Each time the HAD list is broadcast, a new HAD list ID is used, so the receiving mobile devices can determine when to apply their local copies of the HA list.

At step 408, the server broadcasts the HAD list.

Once a location is added to the HAD list, it can automatically be cleared if a sensor in the HA detects a reduced level of the hazardous condition and the sensor determines that the current location is on the HAD list. The sensor can notify the remote server of the current level of the measured condition. Alternatively, on operator can manually clear a particular HAD from the server's HAD list. If a specific HAD needs to be cleared, the Server will provide a new HAD List, having the specific HAD cleared along with the new HAD List ID.

Although the subject matter has been described in terms of exemplary embodiments, it is not limited thereto. Rather, the disclosure should be construed broadly, to include other variants and embodiments, which may be made by those skilled in the art.

For example, the mobile devices and sensors described herein can be based on the hardware platforms of tags, mobile devices and sensors, respectively, as described herein or in any of U.S. patent application Ser. No. 12/943,990, filed Nov. 11, 2010, now U.S. Pat. No. 9,097,787, International Application No. PCT/US2014/13312, filed Jan. 28, 2014, (International Publication No. WO 2014/120649), The devices can use any of the device location methods described herein or in any of the patent publications referenced in this paragraph. The alert system described herein can be used in combination with the behavior monitoring methods described herein or in any of the applications referenced in this paragraph. For example, the behavior of any person in one of the HAs can be monitored by the methods described herein or in WO 2014/120649, U.S. Pat. No. 9,097,787.

According to some embodiments, a system includes a server, a sensor (e.g., gas sensor) at a known location (or movable with a first location detection device, such as a GPS receiver), and a second location device coupled to or an alert device. The second location device can be integrated with an employee's badge, or other wearable article, as described above. The system server will transmit alert information to the second device when the calculated gas concentration at the location of the second device is above a threshold, based on gas detection data from a first device. The criterion is based on a calculated gas concentration at the location of the second device, and not based solely on distance (The concentration varies based on a plurality of factors, which can include distance, rate of leakage at the gas source, wind speed, or the like.

The sensors, location devices and alert device can be any of the devices described with respect to FIGS. 11-18.

The server calculates the gas concentration at the location of each second location device, based on the concentration detected by the sensor and the distance between the sensor and the second location device. The server sends an alert to the alert device at the second location device, if the calculated gas concentration at the location of the second device is at or above a threshold. The server does not send an alert to the alert device at the second location, if the calculated gas concentration is below the threshold. Thus, if the detected gas concentration is very high, the server may send an alert to a second location device that is relatively far from the source of the gas leak. Conversely, if the detected gas concentration is very low, the server may not send an alert to a second location device that is relatively close to the source of the gas leak.

### Calculating an Estimated Gas Concentration at any 3D Location Using a Single Remote Gas Sensor Measurement.

Some embodiments include a method of calculating the gas leakage spot location coordinates and the estimated gas concentration at the original leaking spot location using a plurality of gas sensor measurements provided by a plurality of gas detectors located in proximity to the leak. Some embodiments include alarming the person at his location if the estimated gas concentration at his location is above the limit, while the estimation is done considering the gas concentration and the location of the leaking spot.

The calculation assumes a certain gas propagation model. Assume a single static or portable gas detector resides in the desired area, at the location of the gas leak, which is the location of maximum gas concentration. All other employees have only portable RTLS and data communication devices. Using portable RTLS devices, the system keeps tracking of every person's geographical location. If any portable or stationary gas detector, residing in the same area, generates an alert on a gas concentration exceeding the pre-defined boundaries, the system server will then calculate the estimated gas concentration at each employee's location (i.e., at the current location of each second location device). If the estimated concentration at each employee's current location is outside the pre-configured boundaries (i.e., above a threshold concentration), the server notifies the person at that location immediately by issuing an alert signal to the alert device at the location of the employee (which will be the location of the second location device of that employee). The data communication device will be used to notify the person. For example, considering a first gas propagation model, assuming that: the gas is ideal, the leak event is short in time, and the gas is propagating in the ideal sphere, ignoring any additional influences (wind, temperature changes and etc.), the formula for the gas concentration at each x, y, z location will be as following:

$${C}_{x , y , z} = \frac{{C}_{0} \cdot {L}_{0}^{3}}{{( \sqrt{{( x - {x}_{0} )}^{2} + {( y - {y}_{0} )}^{2} + {( z - {z}_{0} )}^{2}} )}^{3}} \qquad ( 1 )$$

### Where:

C_{x,y,z}—gas concentration at x, y, z location

C₀—measured gas concentration at x₀, y₀, z₀ location

L₀—minimum distance from the x₀, y₀, z₀ location where the concentration assumed almost equal to the original measured concentration C₀, L₀>0

An alternative advanced gas propagation model can take into consideration the actual gas molecular parameters, the ambient conditions, including: wind, temperature distribution, terrestrial conditions, etc. Whichever gas propagation model is used, the model calculates a gas concentration at each employee's current location, where the location is determined by an individual location device movable with the employee.

In other embodiments, a plurality of sensors are used to measure the gas concentration at a plurality of locations, and provide a more accurate three-dimensional gas concentration model, which can estimate the location of the gas leak. Some embodiments use more than one remote portable gas sensors to estimate the actual x, y, z location of a gas leakage along with its initial concentration at that location, assuming a single leak at the time and the propagation conditions specified above.

Assume more than one person may reside in the proximity to the leaking spot, having a gas detector integrated with the RTLS and data communication unit, reporting the measured gas concentration along with the current location.

Based on (1) the equivalent equations can be written for each and every reporting gas detector:

$${c}_{0} \cdot {L}_{0}^{3} = {C}_{{x}_{1} , {y}_{1} , {z}_{1}} \cdot {( \sqrt{{( {x}_{1} - {x}_{0} )}^{2} + {( {y}_{1} - {y}_{0} )}^{2} + {( {z}_{1} - {z}_{0} )}^{2}} )}^{3} \\ {c}_{0} \cdot {L}_{0}^{3} = {C}_{{x}_{2} , {y}_{2} , {z}_{2}} \cdot {( \sqrt{{( {x}_{2} - {x}_{0} )}^{2} + {( {y}_{2} - {y}_{0} )}^{2} + {( {z}_{2} - {z}_{0} )}^{2}} )}^{3} \\ {c}_{0} \cdot {L}_{0}^{3} = {C}_{{x}_{3} , {y}_{3} , {z}_{3}} \cdot {( \sqrt{{( {x}_{3} - {x}_{0} )}^{2} + {( {y}_{3} - {y}_{0} )}^{2} + {( {z}_{3} - {z}_{0} )}^{2}} )}^{3} \\ {c}_{0} \cdot {L}_{0}^{3} = {C}_{{x}_{4} , {y}_{4} , {z}_{4}} \cdot {( \sqrt{{( {x}_{4} - {x}_{0} )}^{2} + {( {y}_{4} - {y}_{0} )}^{2} + {( {z}_{4} - {z}_{0} )}^{2}} )}^{3} \qquad ( 2 )$$

### Where:

c₀—initial gas concentration at the leaking spot location

x₀, y₀, z₀—location coordinates of the leaking spot, which can be calculated as the concentration at the centroid of the gas concentration values, taking each measured concentration and respective location into account.

L₀—minimum distance from the x₀, y₀, z₀ location where the concentration can be assumed equal to the original measured concentration C₀, L₀>0
C_{x,y,z}—gas concentration measured in x, y, z location

x, y, z—location coordinates where measurements have been taken

In this system of equations, the unknown parameters are: c₀ and x₀, y₀, z₀
Resolving the system of equations (2) in respect to the initial concentration c₀ and the leaking spot location coordinates x₀, y₀, z₀, those unknown values can be calculated.

As mentioned above, in other embodiments, an alternative advanced gas propagation model can be used that may take into consideration the actual gas molecular parameters and the ambient conditions, including: wind, temperature distribution, terrestrial conditions and etc.

In either case, using the calculated concentration values at the location of each employee's location device, the system can estimate a gas concentration at each geographical location within the desired area.

Thus, some embodiments include a method comprising: receiving a gas concentration measurement from a sensor at a known first location, receiving location information from a location device at a second location, calculating a gas concentration at the second location, and issuing an alert to an alert device at the second location if the calculated gas concentration at the second location is equal to or greater than a threshold value.

Some embodiments include a method comprising: receiving a gas concentration measurement from a sensor and first location information from a first location device proximate the sensor, receiving second location information from a second location device, calculating a gas concentration at the second location, and issuing an alert to an alert device at the second location if the calculated gas concentration at the second location is equal to or greater than a threshold value.

Some embodiments include a method comprising: receiving gas concentration measurements from a plurality of sensors and respective first location information from respective first location devices proximate to each respective sensor, receiving second location information from a second location device, calculating a location of a source of a gas leak based on the gas concentration measurements and corresponding first locations; calculating a gas concentration at the second location, and issuing an alert to an alert device at the second location if the calculated gas concentration at the second location is equal to or greater than a threshold value.

In some embodiments, a method comprises: receiving a signal from a first device that is part of a tag, the tag adapted to be affixed to a person or object, the receiving being performed by a processor within the tag; analyzing the signal within the processor to determine whether the person or object is performing a predetermined type of behavior; adjusting a variable rate of transmitting a monitoring signal from the tag, based on a result of the analyzing, the adjusting being controlled by the processor; and transmitting the monitoring signal from the tag to an external device separate from the tag at the adjusted variable rate.

In some embodiments, the predetermined type of behavior is a predetermined type of motion; the first device is capable of transmitting respectively different signal patterns corresponding to respectively different types of motion, and the processor is programmed to recognize at least one predetermined signal pattern as representing a performance of the predetermined type of motion by the person or object.

In some embodiments the adjusting includes increasing the variable rate when the at least one predetermined signal pattern is recognized.

In some embodiments, the adjusting includes increasing the variable rate when the signal is not recognized as corresponding to the at least one predetermined signal pattern.

In some embodiments, the monitoring signal is the signal received from the first device.

In some embodiments, the monitoring signal is a signal received from a second device, and wherein transmitting signals from the second device uses more power than transmitting signals from the first device.

In some embodiments, the first device is an accelerometer and the second device is one is a global positioning system (GPS) receiver, a gyro or a transceiver configured to communicate with a plurality of radio frequency beacons.

In some embodiments, the first device measures acceleration, and the second device senses position.

In some embodiments, the predetermined behavior is one of the group consisting of walking, running, jumping, falling and driving.

In some embodiments, the analyzing includes computing a measure of how closely the received signal resembles a signal corresponding to the person or object performing the predetermined behavior and determining the variable rate as a monotonically increasing function of the computed measure.

Some embodiments further comprise: before the receiving step, sampling the signal output by the first device in a learning mode while a person or object performs the predetermined behavior before the receiving step, wherein the analyzing step includes comparing the sampled signal to the received signal.

Some embodiments further comprise storing a representation of at least one predetermined motion pattern in a storage device within the tag before the receiving step, wherein the analyzing step includes comparing the sampled signal to the received signal.

In some embodiments, a method comprises: receiving a signal from a first device within a tag adapted to be affixed to a person or object, the receiving being performed by a processor within the tag; analyzing the received signal over a period of time within the processor to determine whether a behavior of the person or object is changing substantially over the period of time; adjusting a variable rate of transmitting a monitoring signal from the tag, based on the analyzing, the adjusting being controlled by the processor; and transmitting the monitoring signal from the tag to an external device separate from the tag at the adjusted variable rate.

In some embodiments, the variable rate is adjusted by an amount that increases monotonically as a function of a magnitude of the changing.

In some embodiments, a method comprises: receiving a signal from a first device within a tag adapted to be affixed to a person or object, the receiving being performed by a processor within or on the tag; analyzing the signal within the processor to determine whether a condition is present, the condition being from the group consisting of the person or object performing a first predetermined behavior and the person or object not performing a second predetermined behavior; monitoring a location of the tag if the condition is determined to be present; and transmitting a signal representing the location from the tag to an external device separate from the tag while the condition is present.

In some embodiments, the condition comprises the person or object being in a moving helicopter.

Some embodiments further comprise selecting the condition before the receiving step, the selecting being based on a job position of the person.

In some embodiments, the condition is the person performing a predetermined one of the group consisting of walking, running, jumping, falling and driving.

In some embodiments, a device comprises: a housing adapted to be affixed to a person or object; a first sensor in the housing capable of generating a signal indicative of a behavior of the person or object; a second sensor capable of collecting location data; a processor in the housing, the processor configured for receiving the first signal from the first sensor and analyzing the signal to determine whether a condition is present, the condition being from the group consisting of the person or object performing a first predetermined behavior and the person or object not performing a second predetermined behavior, the processor capable of controlling the second sensor to collect location data according to a schedule selected by the processor based on a result of the analyzing; and a transmitter for transmitting a signal representing the location from the device to an external device separate from the device according to the schedule while the condition is present.

In some embodiments, the first sensor is capable of detecting motion and generating a first signal characterizing the motion.

The methods and system described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising
at least one sensor configured for detecting a predetermined condition;
a server processor configured to receive a communications message reporting the condition detected by the sensor and a location of the sensor, the server processor configured to generate and broadcast a list containing one or more area descriptors, each area descriptor in the list identifying the location of the at least one sensor and a respective area containing the location of the at least one sensor, such that the predetermined condition is expected to be present throughout the respective area;
a location device configured to receive the list of area descriptors, determine whether the location device is within one of the areas; and issue an alert if the location device is within one of the areas.

2. The system of claim 1, wherein the predetermined condition is a concentration of a gas that is at least a threshold value.

3. The system of claim 1, wherein each area descriptor includes a location of a respective area, and a respective radius.

4. The system of claim 3, wherein the concentration of the gas is expected to exceed the threshold value anywhere within the respective radius of the location of the respective area.

5. The system of claim 3, wherein the server is configured to compute each respective radius based on the respective concentration value and the threshold value.

6. The system of claim 1, wherein the alert is an auditory or visual alarm generated by the at least one location device.

7. The system of claim 1, wherein:
the at least one location device is configured to transmit an alarm signal to an alarm device; and
the alarm device is configured for generating an auditory or visual alarm.

8. The system of claim 1, wherein the at least one sensor is a CO sensor or a CO₂ sensor.

9. The system of claim 1, wherein:
the at least one sensor includes a plurality of gas sensors, each gas sensor detecting a respective concentration of a gas at a respective location,
the predetermined condition is a concentration of the gas that is at least a threshold value, and
the server is configured for computing a location of a gas leak based on the respective concentration of the gas at the respective location of each of the plurality of gas sensors.

10. The system of claim 9, wherein the server is configured for computing the concentration at the location of the gas leak based on the respective concentration of the gas at the respective location of each of the plurality of gas sensors.

11. The system of claim 1, wherein the location device is included in a wearable communication device in communication with the server, wherein:
the at least one sensor is configured to communicate with a communications gateway using a first communications protocol,
the communications gateway is configured to communicate with the wearable communication device using a second communications protocol different from the first communications protocol, and
the wearable communication device is configured to transmit data representing a measurement by the at least one sensor to the server.

12. The system of claim 11, wherein the at least one sensor includes at least two sensors, each capable of measuring a respectively different condition, each of the at least two sensors configured to communicate with the same communications gateway.

13. The system of claim 11, wherein the communications gateway is housed in a device that detachably holds the at least one of the sensors.

14. The system of claim 11, wherein the communications gateway is housed in a holster that detachably holds the at least one of the sensors.

15. The system of claim 1, further comprising a wearable communication device in communication with the server, wherein:
the at least one sensor is configured to communicate with the wearable communication device, and
the wearable communication device is configured to transmit data representing a respective measurement by each of the at least one sensor to the server.

16. The system of claim 1, wherein the at least one sensor includes a housing containing:
the location device;
a gas concentration measuring device; and
a wireless communication device.

17. The system of claim 16, wherein the sensor is configured to detect acceleration.

18. A system, comprising:
a wearable liquid sensor configured to transmit signals indicating that a portion of the liquid sensor is immersed in water; and
a wearable location device capable of determining a location of the location device, the wearable location device including a receiver for receiving the signals from the liquid sensor and a transmitter for transmitting first signals indicating the location and second signals indicating a person-overboard condition to a server.

19. The system of claim 18, wherein the liquid sensor is a water detector.

20. A method of providing an alarm in response to a predetermined condition, using the system of claim 1.

21. A system comprising:
at least one sensor configured to transmit signals indicating presence of a substance or a condition;
a wireless communications device capable of receiving the signals, and transmitting information regarding the presence of the substance or the condition along with location or acceleration information, to a remote station.

22. The system of claim 21, wherein the at least one sensor comprises a gas sensor.

23. The system of claim 22, wherein the gas sensor is a CO sensor, a CO₂ sensor. an H₂S sensor, or an O₂ sensor.

24. The system of claim 21, wherein the at least one sensor comprises a liquid sensor.
